(19) United States
(12) Patent Application Publication
(10) Pub. No.: US 2005/0179961 A1
(43) Pub. Date: Aug. 18, 2005

(54) Method system and apparatus for scriptable multifunction device controller

(76) Inventors: Joseph Stanley Czyszczewski, Longmont, CO (US); Michael Haller JR., Niwot, CO (US); Richard Steele Nickell JR., Gaithersburg, MD (US); Ivan Woehr, Boulder, CO (US)

Correspondence Address: KUNZLER & ASSOCIATES, 8 EAST BROADWAY, SALT LAKE CITY, UT, 84111, US

(21) Appl. No.: 10/777,575

(22) Filed: Feb. 12, 2004

(51) Int. Cl. H04N 1/32; H04N 1/04; H04N 1/00; B41J 1/00; G06K 9/36; G06K 9/60; G06K 9/00

(52) U.S. Cl. 358/468; 358/498; 358/400; 358/1.15; 382/305; 382/284; 382/112

(57) ABSTRACT

Disclosed are an apparatus, system, and method for application integration and scriptability. The apparatus may comprise a multifunction device configured with a user interface module that is modifiable, and an engine module that is scriptable. The scriptable engine module may be configured to adapt to multiple applications and subsequently provide an appropriate user interface with accompanying input and output data fields. In one embodiment, the apparatus may be configured with self-contained application interfaces. The application interfaces may be configured to receive document data from a scanner, or alternatively, the application interface may be configured to output document data as an e-mail or fax. The system may include a network, the multifunction device and a plurality of optional services such as printers, e-mail servers, libraries, and databases. The method may include providing the application interfaces, identifying a user, accessing an application, receiving document data from the user, and submitting the document data to the chosen application.

### BACKGROUND OF THE INVENTION

1. Field of the Invention

This invention relates to multifunction devices such as, but not limited to, devices that integrate facsimile, scanner, copier, and printer function, and more particularly relates to multifunction devices with self-contained scriptability and application integration.

2. Description of the Related Art

In order to minimize equipment costs, multifunction devices have begun to replace traditional office printers, copiers, scanners, and fax machines. Currently, multifunction devices may have a direct cable or network connection to a server or desktop computer. Using software residing on the computer or server, the multifunction device is adaptable to many applications. For example, a multifunction device may be used for processing many business related documents such as payroll, contracts, expense accounts, and human resource applications, to name a few. Businesses have invested large amounts of time and resources into systems designed to streamline the examples given. However, the effectiveness of such a centralized business application processing system is reduced when paper is involved.

Previously, for example, a user wanting reimbursement for a business expense would approach a multifunction device, scan in the receipt, send that scanned document to his or her computer, and then submit that scanned document to an expense administrator to be processed. Additionally, many users may share one multifunction device and therefore a user may be required to walk to the other side of the building, scan a document, and return to his or her desk and hope that the document was properly sent. This type of solution is not cost effective. Alternative solutions require a separate server for processing the expense information. For example, the server may be required to identify the user and what the user is trying to accomplish.

Additionally, conventional multifunction devices are generally based upon proprietary device controllers and small touch screen user interfaces. The device controllers are hardwired into the multifunction device and offer little, if any, flexibility or upgradeability for new or improved business applications. The small touch screen user interface creates difficulty when a user desires to send a scanned or copied document to a remote location via fax or email because the touch screen buttons are small and few in number.

What is needed is a process, apparatus, and system for a multifunction device that is modifiable to multiple business applications and has self-contained application integration. Such a process, apparatus, and system would be even more beneficial if provided with a scriptable, integrated user interface.

### BRIEF SUMMARY OF THE INVENTION

The present invention has been developed in response to the present state of the art, and in particular, in response to the problems and needs in the art that have not yet been fully solved by currently available multifunction devices. Accordingly, the present invention has been developed to provide a process, apparatus, and system that overcome many or all of the above-discussed shortcomings in the art.

The apparatus of the present invention is a standalone multifunction device comprising a user interface module that is modifiable and configured to adapt to a plurality of business application interfaces. A controller module is scriptable and configured to control the operation of the multifunction device and interface with business applications. An input device incorporating a graphical user interface is provided as well as a source interface module configured to receive input data from at least one document data source and a target interface module configured to output processed document data.

In one embodiment, the multifunction device may also comprise a plurality of application integration modules configured to interface with the scriptable multifunction device controller and provide input and output fields to the modifiable user interface module. Additionally, the application integration modules may be configured to interface with a specified business application. In one embodiment of the present invention, the multifunction device may also comprise a scanning device configured to transmit document data to the source interface. Furthermore, the multifunction device may comprise a printing device configured to receive document data from the target interface.

The multifunction device may also comprise a communications module configured to transmit and receive data over a plurality of data communication connections. In certain embodiments, the communications module may be configured to output processed document data as a facsimile or as an e-mail. Alternatively, the communications module may be configured to output processed document data to an external device such as a server or separate fax machine.

In one embodiment of the present invention, a networked system is provided. The network may comprise a server, a multi function device, a multifunction device interface module configured to communicate with a plurality of multifunction devices over a data communications network, a facsimile module configured to send facsimiles, and an e-mail module configured to send e-mails. Additionally, the facsimile module may comprise a facsimile apparatus configured to communicate with the server over a data communications network. Also, the e-mail module may comprise an e-mail server configured to communicate with the server over a data communications network.

The present invention may also comprise a method for document management. In one embodiment, the method comprises providing a multifunction device with a scriptable user interface module, identifying a user, accessing a business application interface, receiving user information, inputting document data, confirming information, interfacing with a business application, submitting document data to the business application, and providing a final confirmation to the user. Identifying a user may comprise using an identification card or requiring that the user enter a username and password. In one embodiment, the method further comprises previewing the data to be submitted before interfacing with the chosen business application.

The invention may also comprise a computer readable storage medium comprising computer readable code configured to carry out a process for business document management. In one embodiment, the process may comprise identifying a user, choosing a business application interface, entering user information, inputting document data, interfacing with business application, submitting document data to the business application, and providing final success or failure confirmation to the user.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a multifunction device system in accordance with the present invention;

FIG. 2 is a schematic block diagram illustrating one embodiment of a multifunction device controller module in accordance with the present invention;

FIG. 3 is a schematic flow chart diagram illustrating one embodiment of a method of operation of the multifunction device in accordance with the present invention;

FIGS. 4a and 4b are schematic flow chart diagrams illustrating one embodiment of a method of use of the multifunction device in accordance with the present invention; and

FIGS. 5-10 are schematic block diagrams illustrating examples of screens displayed to a user of the multifunction device in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

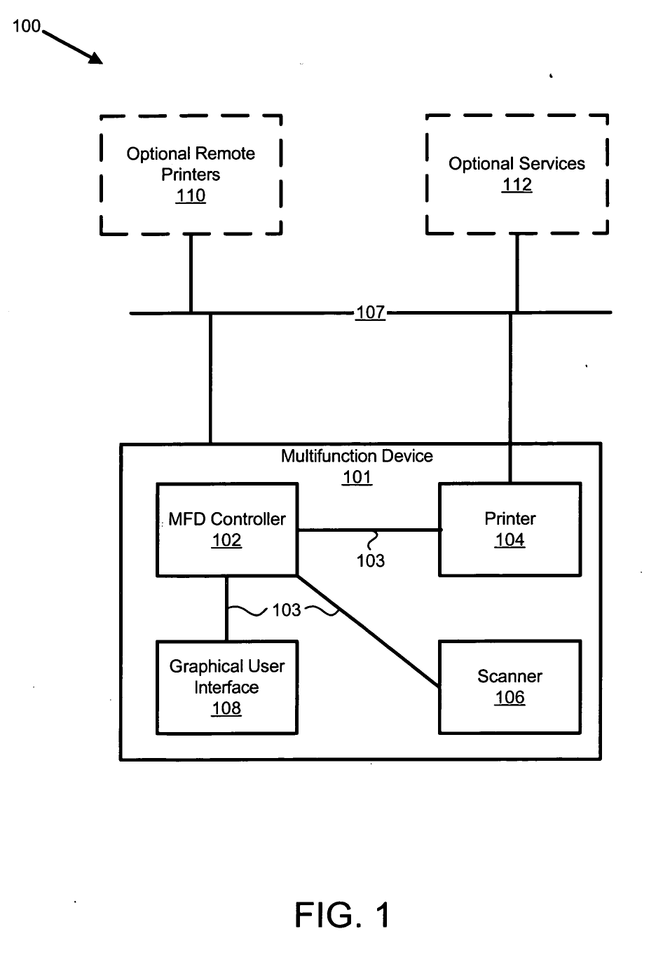

Referring now to FIG. 1, shown therein is a schematic block diagram illustrating one embodiment of a system 100 incorporating a standalone multifunction device (MFD) 101 of the present invention. As defined herein, a standalone multifunction device 101 refers to a multifunction device configured for interfacing with a user and an application without the need of a computer for processing document information. In one embodiment, the standalone multifunction device 101 comprises a MFD controller 102, a plurality of data communication channels 103, a printer 104, and an input device incorporating a graphical user interface (GUI) 108. Additionally, the standalone multifunction device 101 may be connected to a computer network 107. The MFD controller 102 is configured to communicate with the scanner 106 and the graphical user interface 108 over any suitable communication channels 103, such as a local area network, serial or parallel interface, or the like. In one embodiment of the present invention, the communication channel 103 may comprise a SCSI interface, which is well documented and known to those skilled in the art.

The printer 104 may be coupled separately to the global communications network 107 so that it may be accessed from other document sources, such as additional multifunction devices 101. The MFD controller 102 is also preferably coupled to the computer network 107 and is configured to utilize scanning, printing, copying, and sending capabilities of other multifunction devices 101. The computer network 107 may be a global communications network such as the Internet or a local area network, wide area network, or the like. Additionally, optional services 110, 112 may be available on the computer network 107. The optional services may include, but are not limited to, remote printers 110, e-mail, facsimile, directory, security, and library services and data storage services.

The scanner 106 and printer 104 may be any commercially available devices using industry standard interfaces to the MFD controller 102. In one embodiment, this provides an advantage in that the MFD controller 102 may be easily integrated with scanning and printing devices already in place.

The graphical user interface 108 may be configured as a touch screen LCD (not shown), or alternatively the graphical user interface 108 may be configured with common human interface devices such as a light pen, a keyboard and/or a mouse (not shown). The graphical user interface 108 may be configured to communicate with the MFD controller 102 over the data communication channel 103. Additionally, the graphical user interface 108 maybe configured to communicate user commands to the MFD controller 102. Such commands might include, but are not limited to, user identification, scanning, faxing, emailing, copying, and submitting business related documents.

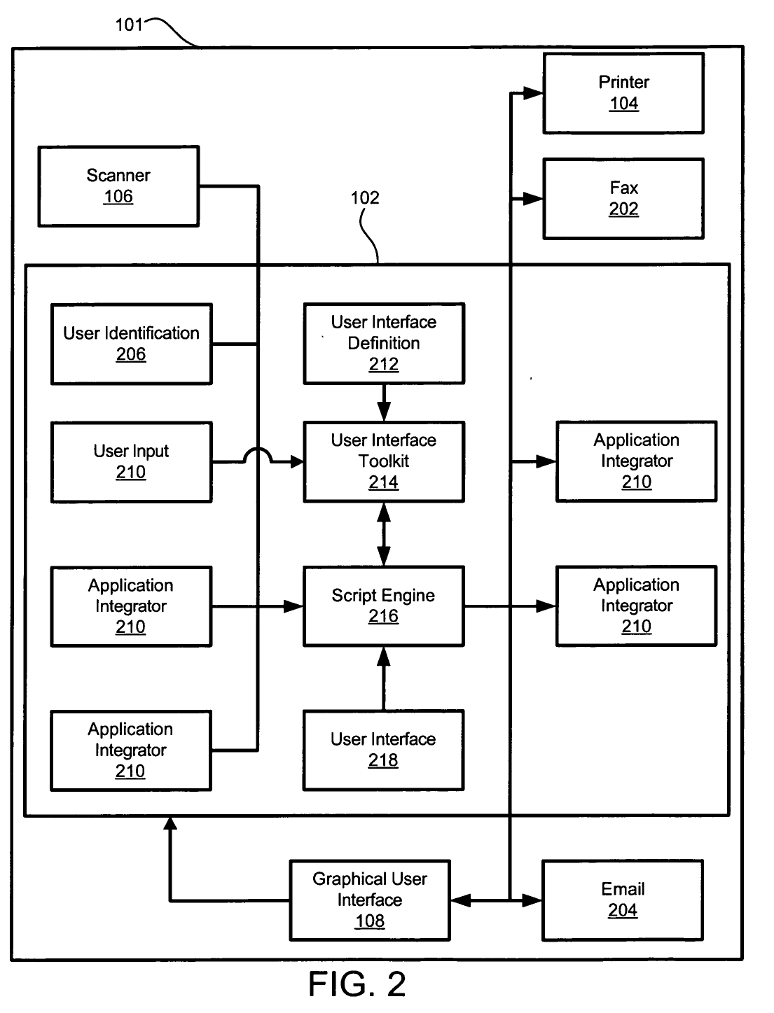

FIG. 2 is a schematic block diagram illustrating one embodiment of the standalone multifunction device 101. Shown therein are the MFD controller 102, the printer 104, the scanner 106, and the graphical user interface 108 of FIG. 1. Optional external modules include a fax module 202 and an email module 204. In the depicted embodiment, the fax module 202 and the email module 204 may be internal, application-based services configured to communicate with the MFD controller 102. Alternatively, the fax module 202 and the email module 204 may comprise remote fax and email devices configured to communicate with the MFD controller 102 over a data communication network (not shown), such as the data communication channels 103 of FIG. 1.

In one embodiment of the present invention, the MFD controller 102 comprises a user identification module 206, a user input module 208, a plurality of application integrator modules 210, a user interface (UI) definition module 212, a UI toolkit 214, a script engine module 216, and a UI module 218. The user identification module 206 may be configured as an externally coupled identification card reader configured to receive an identification card from a user and compare the user information to a local database (not shown) or remote database 112. Alternatively, the user identification module 206 may comprise, but is not limited to, a retinal scanner, fingerprint biometric system, or badge scanner. In one embodiment, the user identification module 206 may be configured to communicate with the script engine module 216 and cause a login screen to appear on the graphical user interface 108.

In a further embodiment, the user input module 208 may be configured to receive user commands from the graphical user interface 108. In one embodiment, the user input module 208 is further configured to communicate the user commands with the user interface toolkit 214.

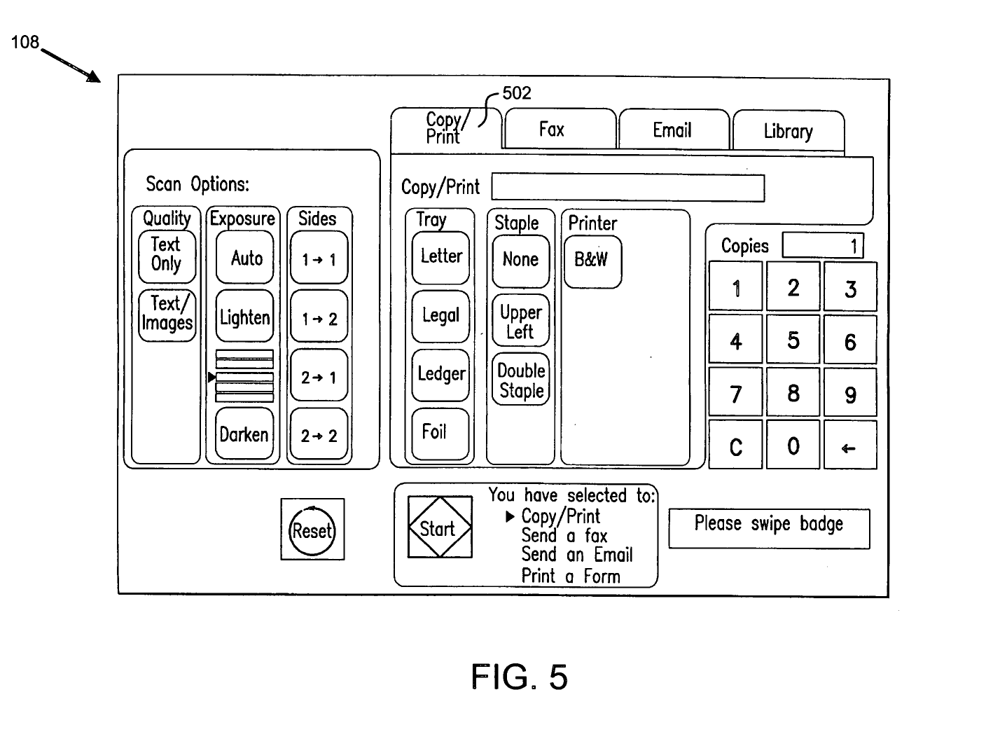

One advantage of the present invention is the modifiability of the application integrator modules 210. A user may configure an application integrator 210 to operate as both document data input and output. For example, one application integrator module 210 may be configured as an integrated business expense application, with the ability to communicate with the script engine module 216 and thereby display an appropriate user interface on the graphical user interface 108. Different embodiments of such user interfaces will be explained with greater detail below with reference to FIGS. 5-10.

Additionally, the application integrator modules 210 may be configured to receive processed document data from the script engine module 216 and output the processed document data. In one embodiment, an application integrator module 210 may emulate a fax machine and send processed document data to a remote fax server (not shown). Alternatively, the application integrator module 210 may be configured as a communications module to send messages or e-mails over a data communications network such as the global communications network 107 of FIG. 1.

In one embodiment, the plurality of application integrators 210 is configurable as upgradeable applications operating within the standalone multifunction device 101. For example, the user may develop proprietary business application interfaces and load these interfaces onto the standalone multifunction device 101 through a management port (not shown). Alternatively, the interfaces may be loaded over data communication channels 103. In a further embodiment, the user may download and install a plurality of application integrators 210 from a global communications network.

One advantage of the present invention is the ability to modify the standalone multifunction device 101 to interface with a specific application. The user may configure the standalone multifunction device 101 by modifying the user interface definition module 212 and the user interface module 218. In one embodiment, the user interface definition module 212 and the user interface module 218 may be configured to receive user defined scripts or programs in order to modify the standalone multifunction device 101. For example, the user definition module 212 may be configured to store a plurality of data objects. These data objects may be proprietary and business application specific. Additionally, the user interface module 218 may be configured to receive, store, and execute programs created in Java, C++, or the like.

In a further embodiment, the user interface toolkit 214 is configured to communicate with the user interface definition module 212 and the user input module 210 in order to communicate user commands into the script engine module 216. Additionally, the user interface module 218 may be configured with user commands, programs, scripts, or the like, in order to modify the functionality of the standalone multifunction device 101.

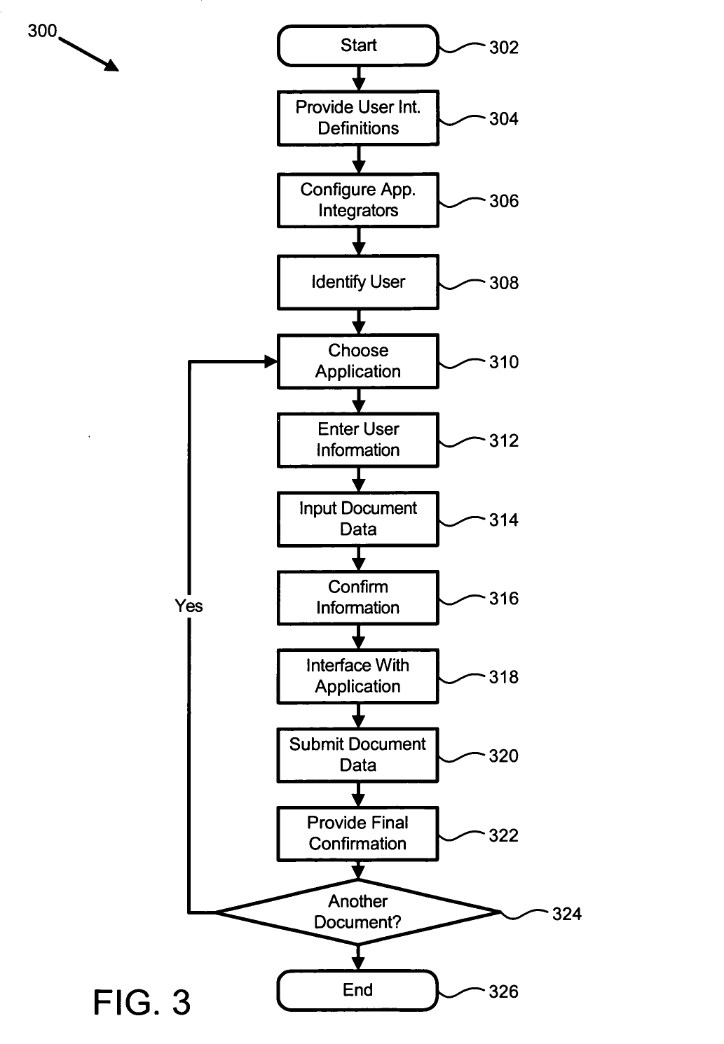

Referring now to FIG. 3, shown therein is a schematic flow chart diagram illustrating one embodiment of a method 300 for controlling the standalone multifunction device 101. The method 300 starts 302 and user definitions are received 304. In one embodiment, the standalone multifunction device 101 is configured to receive user definitions through, but is not limited to, a management port (not shown) or over the data communications network 107. Once the definitions are received 304, the multifunction device may then be configured 306 with the plurality of application integrator modules 210. For example, application integrator modules 210 may be configured 306 as integrated programs designed for payroll, contracting, expense accounting, human resource managing, document presenting, document submitting, etc.

The standalone multifunction device 101 may now identify 308 a user. In one embodiment, the user is identified 304 as described previously with reference to module 206 of FIG. 2. An application is chosen 310, and the standalone multifunction device 101 receives 312 user information. The user information may comprise job, account, or personal data. The standalone multifunction device 101 then receives 314 document data. Document data maybe received 314 from the scanner 106 or from remote devices. In one embodiment, a remote device may comprise other multifunction devices 101. After receiving 314 the document data, the multifunction device confirms 316 the action the user desires to effect. The standalone multifunction device 101 may then interface 318 with the chosen application and then submit 320 the document data. Final confirmation is provided 322 by the standalone multifunction device 101, and the user may choose to input 324 another document, or alternatively terminate 326 the session.

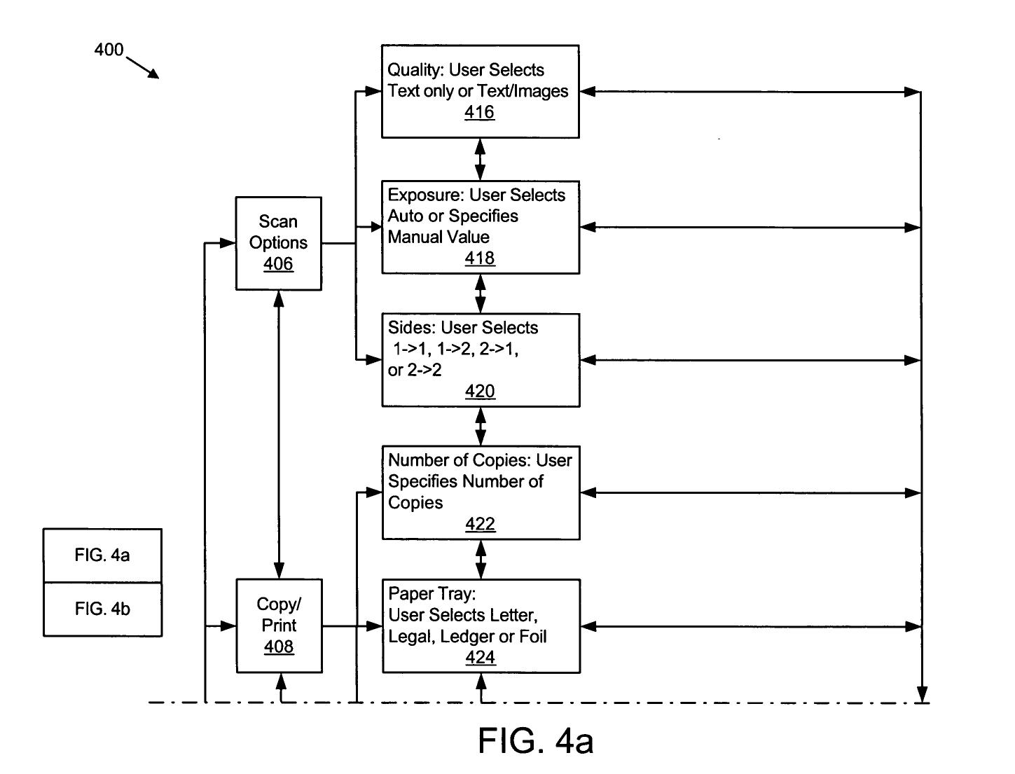

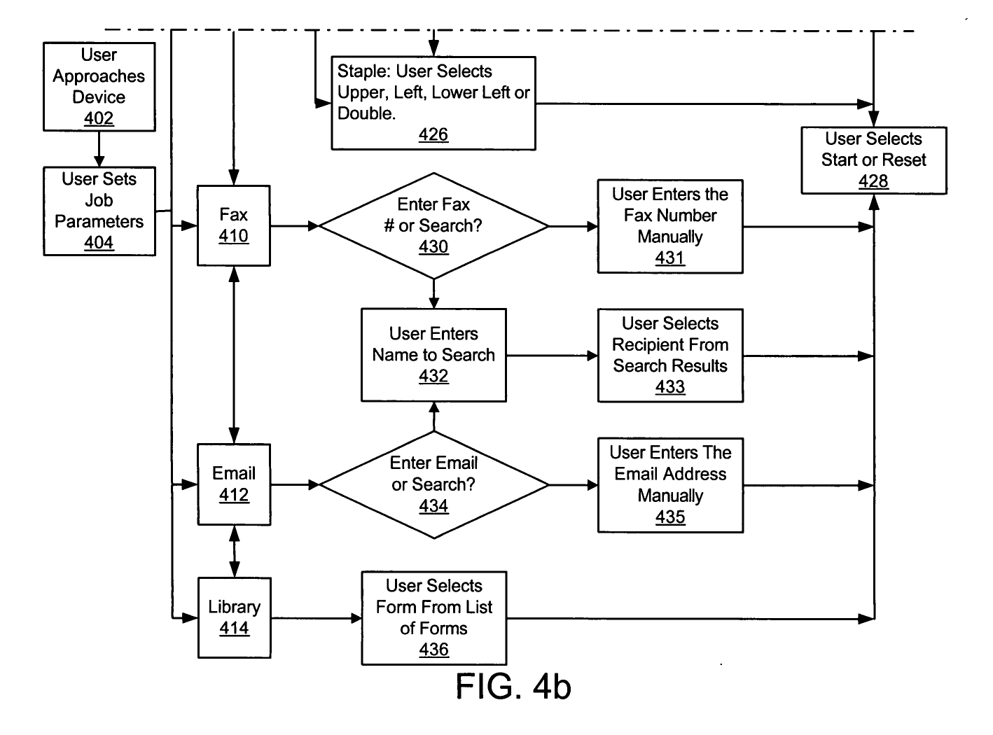

FIGS. 4a and 4b together illustrate one method 400 of user control of the standalone multifunction device 101. First, a user approaches 402 the standalone multifunction device 101, and the user sets 404 the parameters for a particular job. In one embodiment, setting the parameters 404 comprises selecting and setting parameters for one or a plurality of job types. The job types or options that can be selected using the GUI 108 include, but are not limited to, scanning 406, copy/printing 408, faxing 410, e-mailing 412, and accessing a library 414. Additionally, a user may select more than one option while performing a single job. For example, the user may scan 406 a document, as well as print 408, fax 410 and then e-mail 412 the scanned document. Alternatively, the user could select the archive 414 to access a particular form, and subsequently print 408 the selected form.

When selecting scanning 406 or copying/printing 408, the user may further define a number of job parameters, or, alternatively the user may simply use default parameters. The user-settable job parameters include, but are not limited to quality 416, e.g. text or image/text, exposure 418, number of sides 420, number of copies 422, paper tray 424, e.g., letter/legal, and staple options 426. While not specifically indicated in FIGS. 4a and 4b, the various scan options can preferably be set at any time, such as when setting copy, fax, e-mail and archive options. A user may select 416-426 none, one, some or all of the options while performing a particular job. After making a selection, the user then starts 428 the job, or resets 428 the job at which point the method 400 starts again at block 402.

If the user selects the fax 410, the GUI 108 displays appropriate selection fields where the user may enter 431 a fax number. Alternatively, the user may search 432 a directory database 112 for the fax number, and select 433 a recipient from the search results. The user may then start or cancel 428 the job. Alternatively, if the user selects e-mail 412, the GUI 108 displays appropriate selection fields wherein the user may choose 434 to enter 435 an e-mail address or search 432 as described above. The user may then start or cancel 428 the job. Finally, if the user selects the library 414, the user may select 436 a form from the list of forms maintained by the database 112. The user may then print 408, fax 410, or email 412 the selected form.

FIGS. 5-10 are schematic block diagrams showing multiple embodiments of the GUI 108 of the standalone multifunction device 101. In FIG. 5, the copy/print tab 502 is shown as selected. A user accustomed to the art will recognize the scanning, copying, and printing options as traditional options available on many devices; however, the interface of the GUI 108 is modifiable according to the business application that has been chosen. FIG. 5 is one example of how options may appear to the user. Alternatively, an interface may be displayed with options that are proprietary to a specific business application.

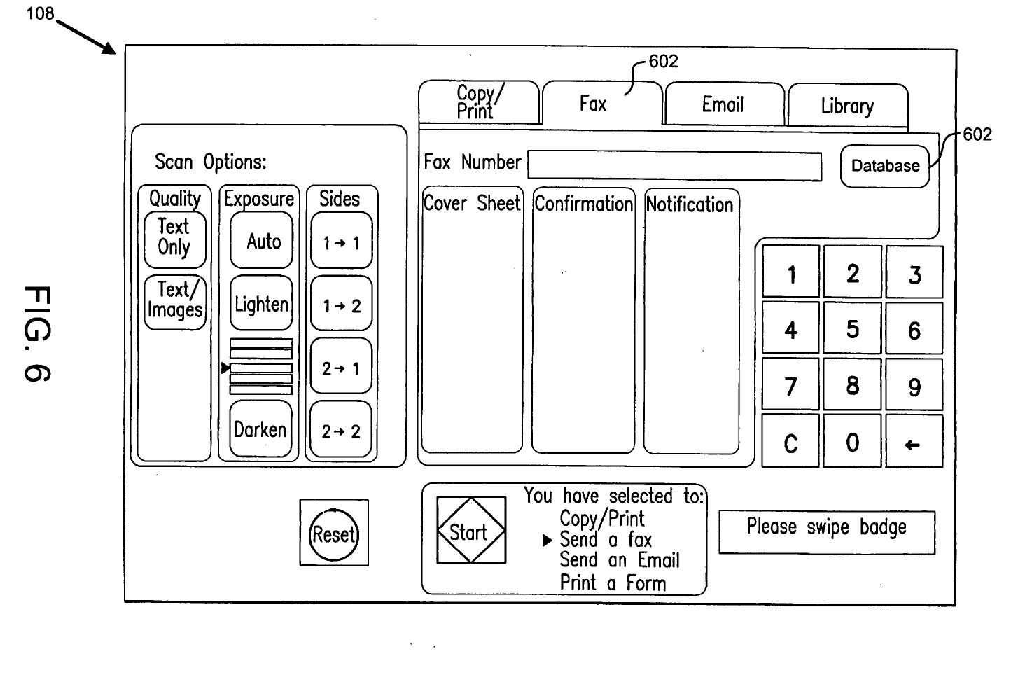

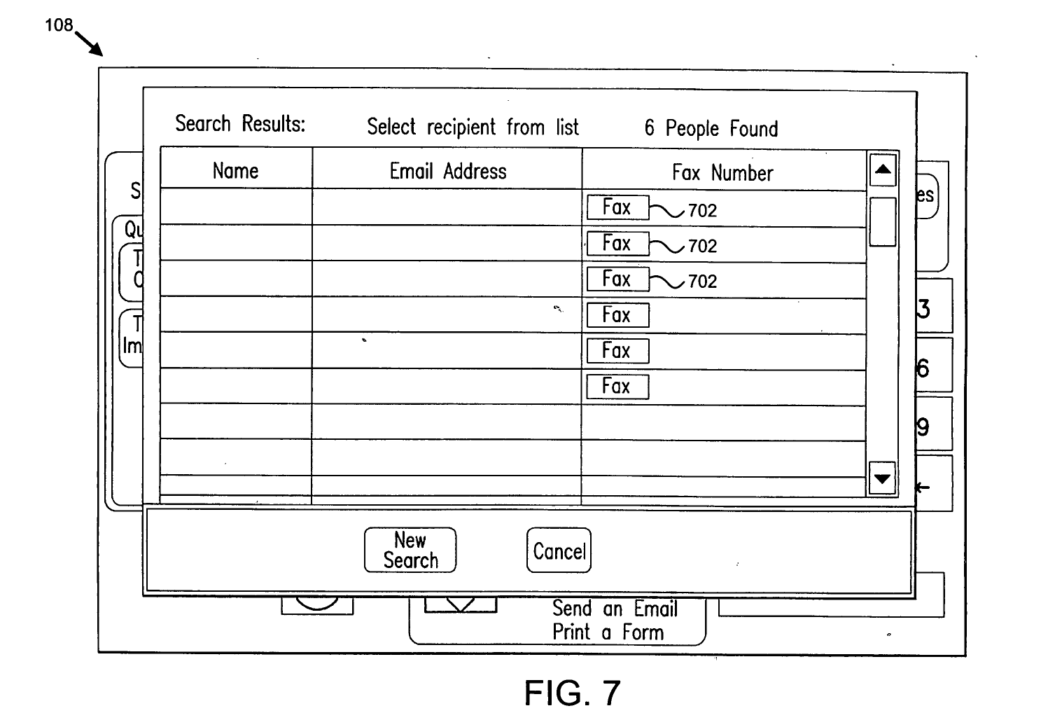

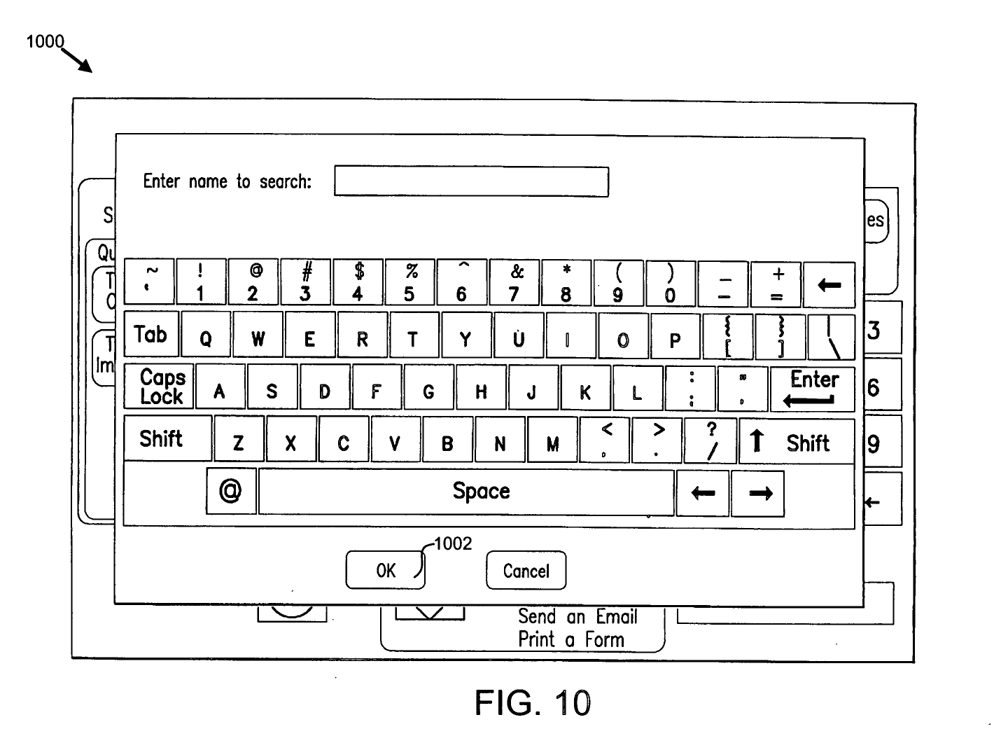

In FIG. 6 a second tab has been selected. The user is enabled to enter a fax number using the numeric keypad, and to select cover sheet options. If a database button 604 is selected instead, a keyboard 1000 of FIG. 10 may be displayed, whereby the user is enabled to enter all or a portion of a name. Upon pressing the OK button, a search is conducted in, for example, the database 112, and a list of possible matching names and fax numbers is displayed (as well as e-mail addresses if available) as shown in FIG. 7. The user may scroll through the list until a desired fax number is found, which may then be selected by pressing the associated fax button 702.

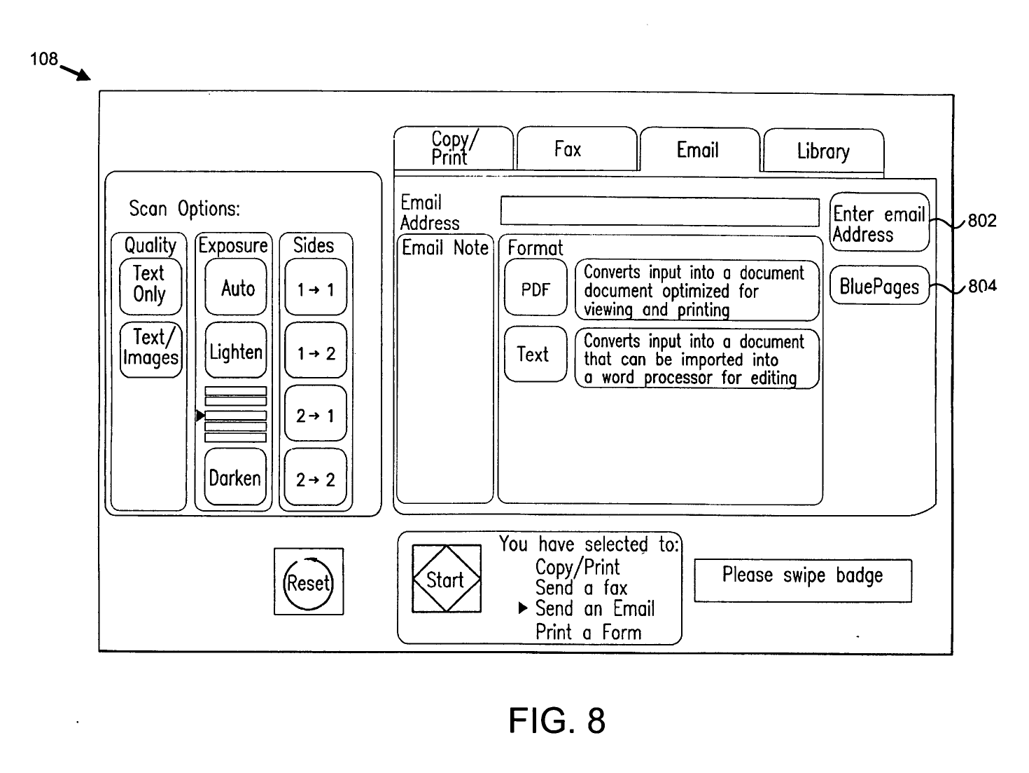

Referring now to FIG. 8, shown therein is a schematic block diagram illustrating one embodiment of a GUI 108 displaying e-mail options. The user may enter an e-mail address by touching the Enter Email Address button 802, which brings up a virtual keyboard 1000 of FIG. 10. If the e-mail address is not known, then the database button 804 may be selected. Again, the keyboard 1000 appears, but instead of entering the complete email, the user may enter any part of an e-mail address, name or the like, and after pressing the ok button 1002, the search is then made in the database 112. FIG. 7 is then shown, and a list of possible matching names and e-mail addresses is displayed.

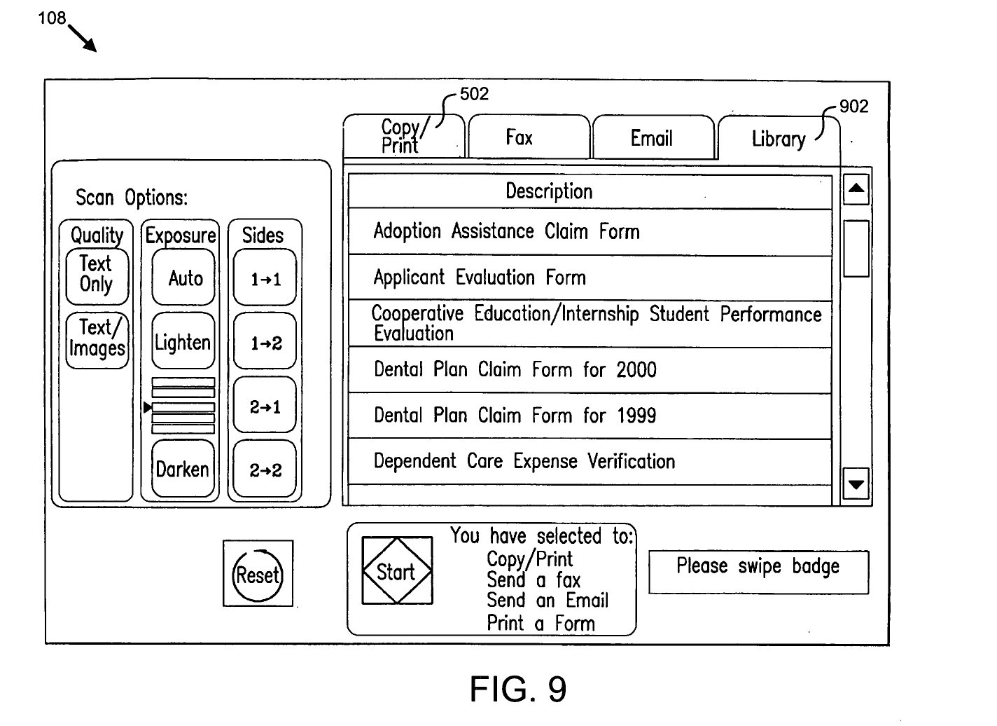

FIG. 9 is a schematic block diagram illustrating one embodiment of a library user interface displayed on the GUI 108. The user may select the library tab 902, and in response, the multifunction controller 102 accesses a database 112 containing forms and displays the current forms index. The user may scroll through the displayed forms index until a desired form is located, which can then be selected by touching the form name. The Copy/Print tab button 502 can then be touched to print or copy the form desired. Alternatively, the form may be faxed or e-mailed to a desired recipient or recipients, as described above.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A standalone multifunction device comprising:
a modifiable user interface module configured to adapt to a plurality of business application interfaces;
an input device incorporating a graphical user interface;
a source interface module configured to receive input data from at least one document data source; and
a target interface module configured to output processed document data.

2. The standalone multifunction device of claim 1, further comprising a scriptable script engine module configured to control the operation of the standalone multifunction device and interface with a business application.

3. The standalone multifunction device of claim 1, further comprising a plurality of application integration modules configured to interface with the script engine module and provide input and output fields to the user interface module.

4. The standalone multifunction device of claim 3, wherein each of the application integration modules are further configured to interface with a specified business application.

5. The standalone multifunction device of claim 1, further comprising a user input module configured to allow a user to customize the input device.

6. The standalone multifunction device of claim 1, further comprising a scanning device configured to transmit document data to the source interface.

7. The standalone multifunction device of claim 1, further comprising a printing device configured to receive document data from the target interface.

8. The standalone multifunction device of claim 1, further comprising a communications module configured to transmit and receive data over a plurality of data communication channels.

9. The standalone multifunction device of claim 8, wherein the communications module is configured to output processed document data as a facsimile.

10. The standalone multifunction device of claim 8, wherein the communications module is configured to output processed document data as an e-mail.

11. The standalone multifunction device of claim 8, wherein the communications module is configured to output processed document data to an external device.

12. The standalone multifunction device of claim 1, wherein the input device is a touch screen apparatus.

13. A system comprising:
a data communications network;
a standalone multifunction device connected to the data communications network;
a modifiable user interface module configured to adapt to multiple business application interfaces;
an scriptable script engine module configured to control the operation of the multifunction device, including interfacing with business applications;
an input device incorporating a graphical user interface;
a plurality of application integration modules, configured to interface with the script engine module and provide a user interface for applications; and
a user input module configured to allow a user to customize the input device.

14. The system of claim 13, further comprising a facsimile apparatus configured to receive document data from the multifunction device and transmit the document data as a facsimile.

15. A computer network system comprising:
a server connected to a network;
a standalone multifunction device connected to the network;
an interface module within the multifunction device, the interface module configured to communicate with a plurality of multifunction devices over the network;
a facsimile module within the multifunction device, the facsimile module configured to send facsimiles; and
an e-mail module within the multifunction device, the e-mail module configured to send e-mails.

16. The computer network system of claim 15, wherein the facsimile module comprises a facsimile apparatus configured to communicate with the server over a data communications network.

17. The computer network system of claim 15, wherein the e-mail module comprises an e-mail server configured to communicate with the server over a data communications network.

18. A method for multifunction device document management, the method comprising:
interfacing with a business application interface;
receiving user information;
inputting document data; and
submitting document data to the business application.

19. A computer readable storage medium comprising computer readable code configured to carry out a process for multifunction business document management, the process comprising:
interfacing with a business application interface;
receiving user information;
inputting document data; and
submitting document data to the business application.

20. An apparatus for multifunction business document management, the apparatus comprising:
means for interfacing with a business application interface;
means for receiving user information;
means for inputting document data; and
means for submitting document data to the business application.
